(19) United States
(12) Patent Application Publication
(10) Pub. No.: US 2008/0282550 A1
(43) Pub. Date: Nov. 20, 2008

(54) BLADE ASSEMBLY

(75) Inventor: John M. Piwaron, Milwaukee, WI (US)

Correspondence Address: MICHAEL BEST & FRIEDRICH LLP, 100 E WISCONSIN AVENUE, Suite 3300, MILWAUKEE, WI, 53202, US

(73) Assignee: Andis Company, Sturtevant, WI (US)

(21) Appl. No.: 12/164,592

(22) Filed: Jun. 30, 2008

(51) Int. Cl. B26B 19/12; B26B 15/00

(52) U.S. Cl. 30/210; 30/228

(57) ABSTRACT

A blade assembly for a hair trimmer having a trimmer body and a motor. The blade assembly includes an upper blade having a forward cutting edge, a lower blade having a forward cutting edge and defining a groove, a support member configured for coupling to the trimmer body and having a protrusion, the protrusion configured to be slidingly received in the groove of the lower blade, an actuation member coupled to the lower blade and extending outwardly from the lower blade, and a biasing member retained by the support member and configured to bias the upper blade against the lower blade. The upper blade is configured to oscillate in a transverse direction relative to forward edge of lower blade during operation of motor. The lower blade is configured to move relative to hair trimmer in a longitudinal direction perpendicular to forward edge of upper blade upon movement of actuation member.

### BACKGROUND

The present invention relates generally to hair trimmers, and more specifically to blade assemblies for use with hair trimmers.

The blade assembly for a hair trimmer typically includes a blade set having a fixed blade in face-to-face relation with a movable blade. An electric motor is drivingly coupled to the movable blade to effect reciprocation of the movable blade (relative to the fixed blade) in response to actuation of the motor. The blade set determines the cut length of the hair, texturizing, or other variations that affect or otherwise influence a hair style.

### SUMMARY

In one embodiment, the invention provides a blade assembly for a hair trimmer having a trimmer body and a motor. The blade assembly includes an upper blade having a forward cutting edge, a lower blade having a forward cutting edge and defining a groove, a support member configured for coupling to the trimmer body and having a protrusion, wherein the protrusion is configured to be slidingly received in the groove of the lower blade, an actuation member coupled to the lower blade and extending outwardly from the lower blade, and a biasing member retained by the support member and configured to bias the upper blade against the lower blade. The upper blade is configured to oscillate in a transverse direction relative to the forward edge of the lower blade during operation of the motor. The lower blade is configured to move relative to the hair trimmer in a longitudinal direction perpendicular to the forward edge of the upper blade upon movement of the actuation member.

In another embodiment, the invention provides a hair trimmer including a housing, a motor at least partially disposed in the housing, and a blade assembly coupled to the housing and drivingly connected to the motor to effect a cutting action. The blade assembly includes an upper blade having a forward cutting edge, a lower blade having a forward cutting edge and defining a groove, a support member configured for coupling the blade assembly to the housing and having a protrusion, wherein the protrusion is configured to be slidingly received in the groove of the lower blade, an actuation member coupled to the lower blade and extending outwardly from the lower blade, and a biasing member retained by the support member and configured to bias the upper blade against the lower blade. The upper blade is configured to oscillate in a transverse direction relative to the forward edge of the lower blade during operation of the motor. The lower blade is configured to move relative to the hair trimmer in a longitudinal direction perpendicular to the forward edge of the upper blade upon movement of the actuation member.

In yet another embodiment, the invention provides a blade assembly for a hair trimmer having a trimmer body and a motor. The blade assembly includes an upper blade having a forward cutting edge, a lower blade having a forward cutting edge, a support plate coupled to the lower blade and defining a groove, a support member configured for attachment to the trimmer body and having a protrusion, wherein the protrusion is configured to be slidingly received in the groove of the support plate, an actuation member coupled to the support plate and pivotally coupled to the support member, the actuation member having an actuation end extending outwardly from the lower blade, wherein the actuation member is configured to adjust a cut length of the blade assembly by moving the lower blade in a longitudinal direction between a first position and a second position, a biasing member retained by the support member and configured to bias the upper blade against the lower blade, and a yoke member supported by the upper blade and drivingly coupled to the motor, wherein the upper blade oscillates in a transverse direction relative to the forward edge of the lower blade during operation of the motor.

In yet another embodiment, the invention provides a blade assembly for a hair trimmer having a trimmer body and a motor. The blade assembly includes an upper blade having a forward cutting edge, a lower blade having a forward cutting edge and defining a groove, an actuation member coupled to the lower blade and extending outwardly from the lower blade, wherein the actuation member includes a plurality of rows of notches, a support member configured for coupling to the trimmer body and having a protrusion and a plurality of projections corresponding to the plurality of rows of notches, wherein the protrusion is configured to be slidingly received in the groove of the lower blade and the plurality of projections is configured to be slidingly received in the plurality of rows of notches, and a biasing member retained by the support member and configured to bias the upper blade against the lower blade.

Other aspects of the invention will become apparent by consideration of the detailed description and accompanying drawings.

### BRIEF DESCRIPTION OF THE DRAWINGS

FIG. 1 is a perspective view of a hair clipper having a blade assembly according to an embodiment of the invention.

FIG. 2 is a top perspective view of the blade assembly of FIG. 1.

FIG. 3 is a bottom perspective view of the blade assembly of FIG. 1.

FIG. 4 is an exploded view of the blade assembly of FIG. 1.

FIG. 5 is a top perspective view of a support member of the blade assembly.

FIG. 6 is a bottom perspective view of the support member of the blade assembly.

FIG. 6A is a bottom perspective view of another support member of the blade assembly.

FIG. 7 is a top perspective view of an actuation member of the blade assembly of FIG. 1.

FIG. 7A is a top perspective view of another actuation member for use with the support member of FIG. 6A.

FIG. 8 is a top view of the blade assembly of FIG. 1 showing the lower blade in a first position.

FIG. 9 is a top view of the blade assembly of FIG. 1 showing the lower blade in a second position.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

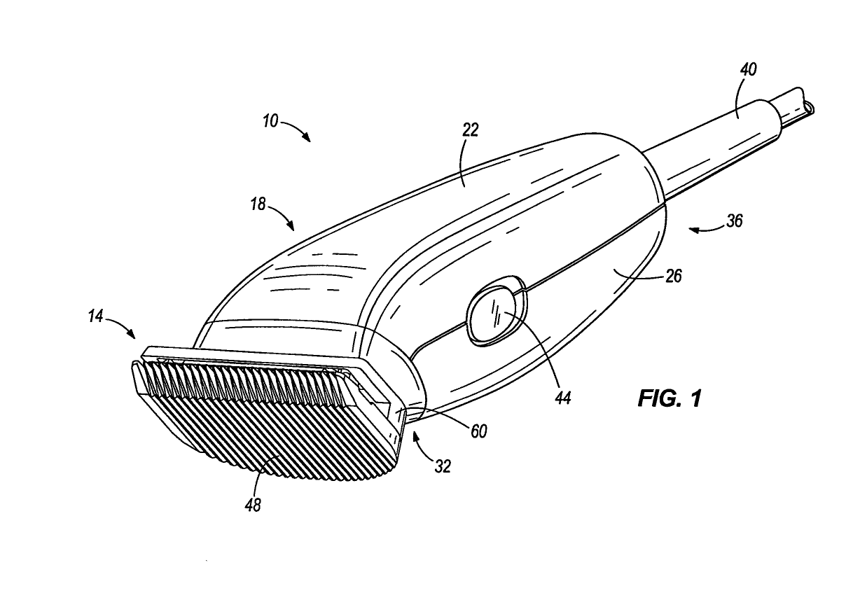

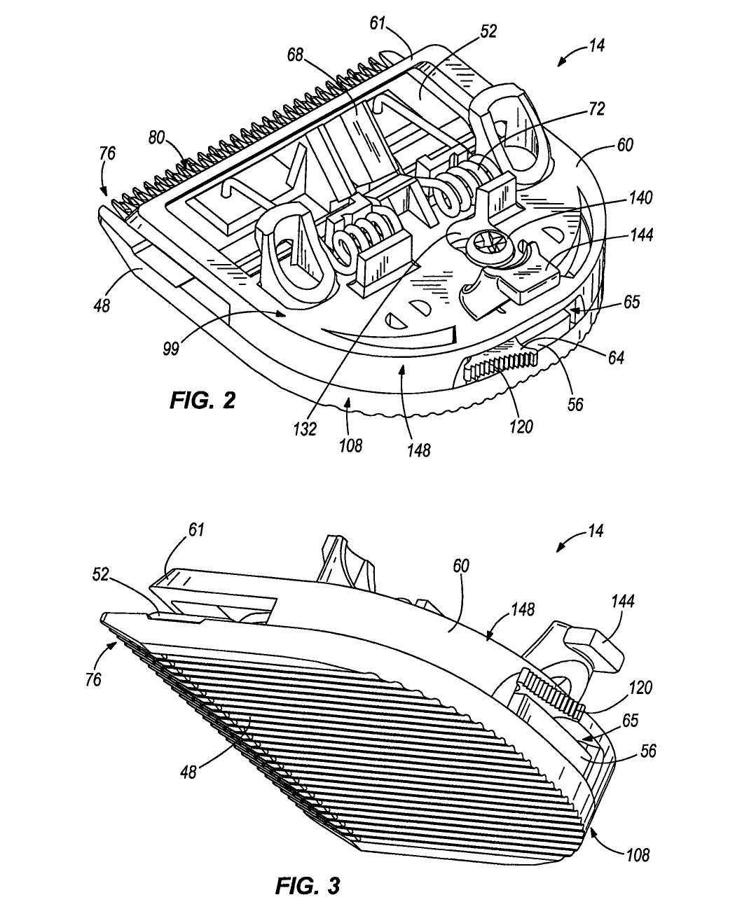

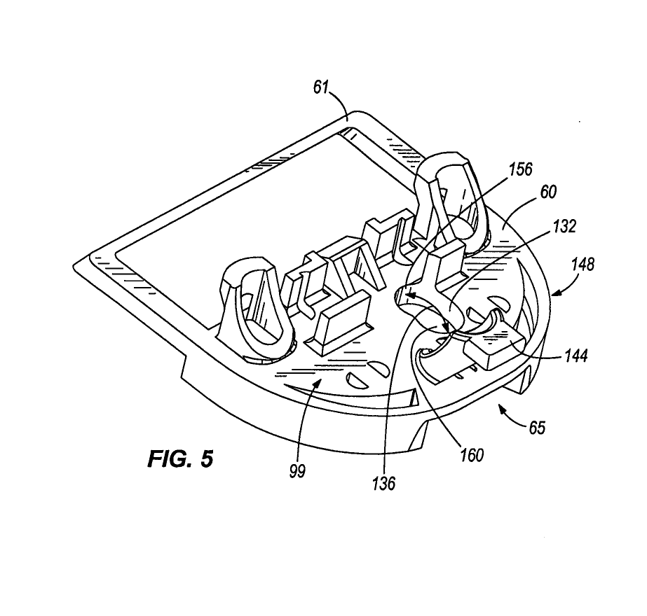

FIGS. 1-9 illustrate a hair trimmer 10 including a blade assembly 14 and blade assembly components according to an embodiment of the invention. More specifically, FIG. 1 illustrates the hair trimmer 10 and the blade assembly 14, FIGS. 2-4 and 8-9 are detailed views of the blade assembly 14, and FIGS. 5-7 illustrate more detailed views of components of the blade assembly 14. The blade assembly 14 is illustrated as a mechanism for use with a hair trimmer to adjust the cut length of a lower blade 48 and permit detachment of the blade assembly 14 from the hair trimmer 10. It should be readily evident to one of ordinary skill in the art that the invention may also be utilized in a hair clipper.

As shown in FIG. 1, the trimmer 10 includes a housing 18 having an upper housing 22 and a lower housing 26. The housing 18 is made of injection-molded plastic, but may be made of any suitable material known in the art. The upper housing 22 and the lower housing 26 are coupled together by a fastening mechanism, including but not limited to, screws, a snap and lock mechanism, or other fastening device or mechanism. The housing 18 includes a cutting end 32 and a power end 36 opposite the cutting end 32. The cutting end 32 is configured to releasably retain the blade assembly 14. The power end 36 includes an electrical connector 40. The electrical connector 40 extends from the power end 36 of the housing 18 and is electrically connected to an external power source and other circuitry to provide a source of electrical power to the hair trimmer 10. The trimmer 10 also includes a switch 44 configured to provide an on/off power function for the hair trimmer 10. In a further embodiment, electrical power includes an alternating current (AC) power provided via a corded plug electrically coupled to a wall outlet and/or a direct current (DC) power provided by a battery (e.g., a rechargeable battery disposed in the cavity). Hair trimmers powered by AC and/or DC power are generally known in the art and, accordingly, are not discussed further herein.

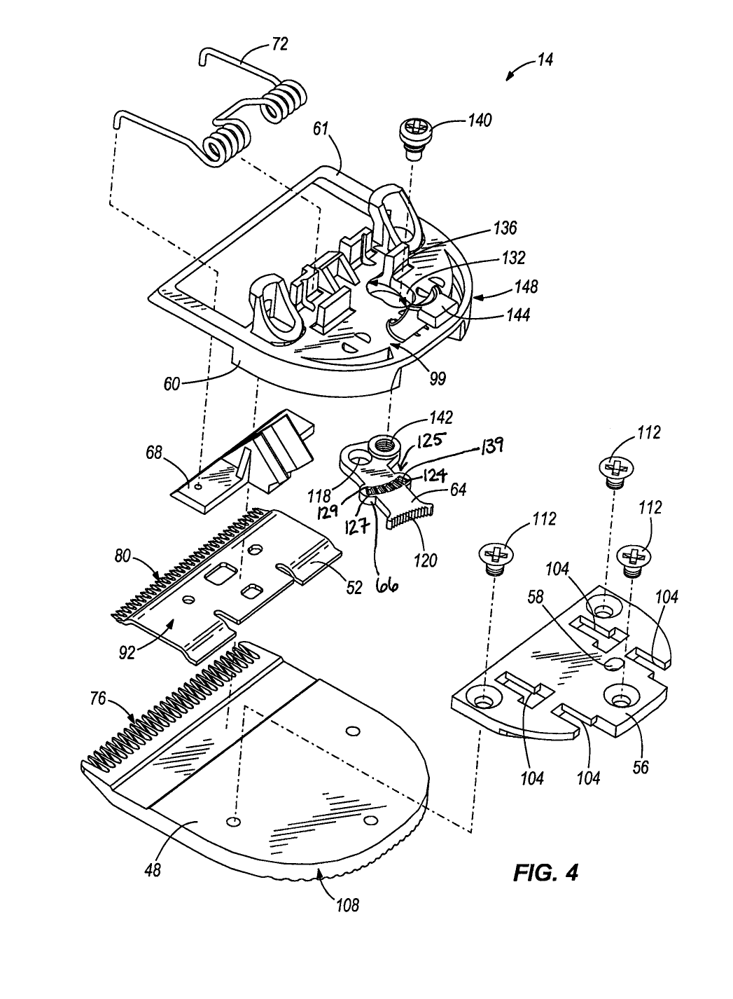

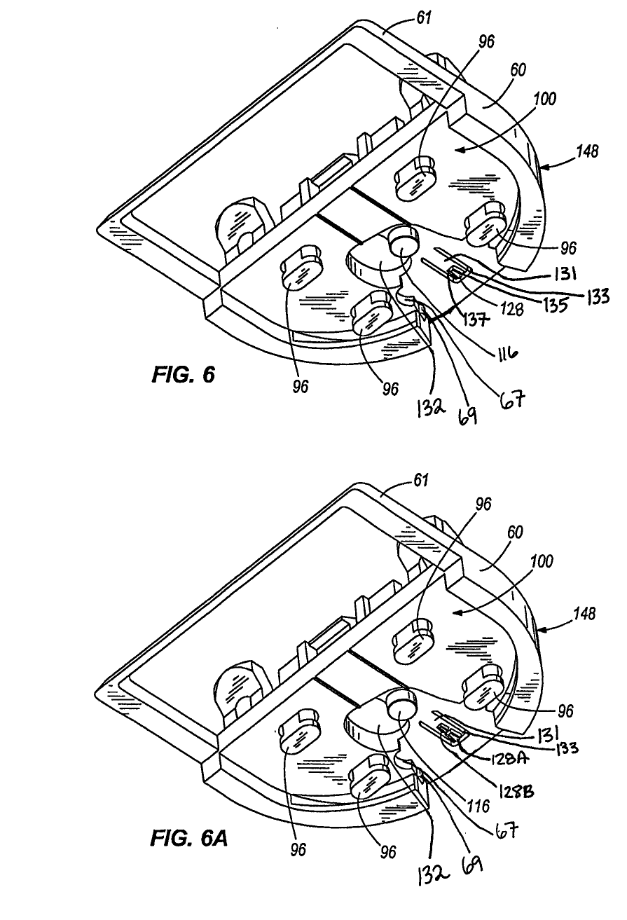

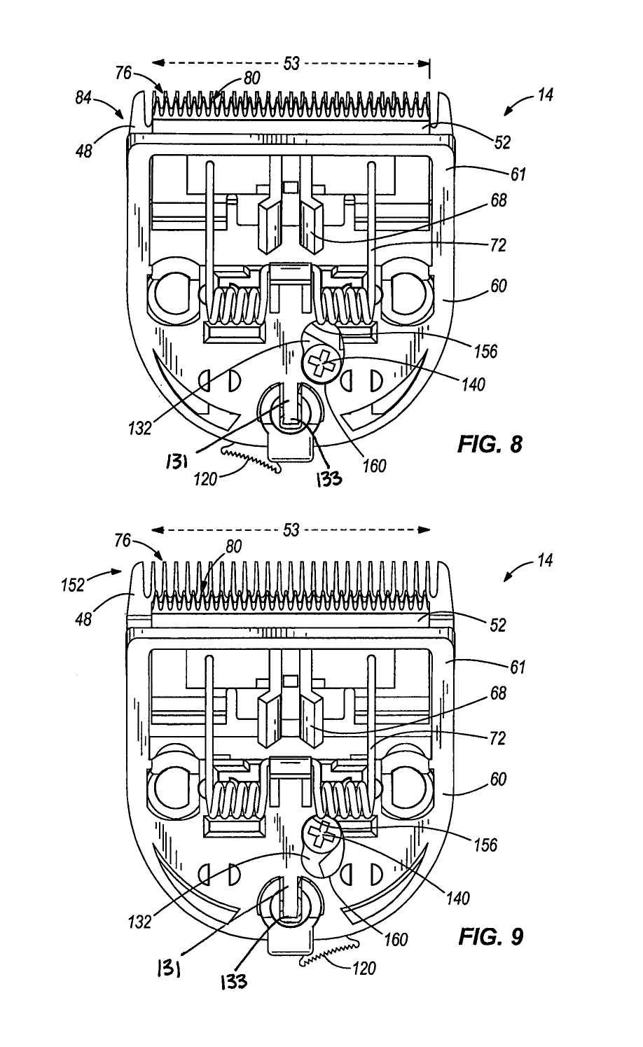

FIGS. 2-4 and 8-9 illustrate the blade assembly 14. The blade assembly 14 includes a lower blade 48, an upper blade 52, a support plate 56, a support member 60, an actuation member 64, a yoke 68, and a biasing member 72. The lower blade 48 includes a forward cutting edge 76, and the upper blade 52 includes a forward cutting edge 80, wherein the forward cutting edges 76, 80 are substantially adjacent and aligned when the lower blade 48 is in a first position 84 (FIG. 8). As shown in FIG. 4, the support plate 56 is coupled to the lower blade 48 with a plurality of fasteners 112. The support plate includes an aperture 58 and four T-shaped grooves 104. The aperture 58 is configured to couple the actuation member 64 to the lower blade 48. Aperture 58 is shown as an oval aperture; however, in other embodiments, the aperture may be circular, square, or any shape configured to receive the actuation member pin 140. The T-shaped grooves 104 are configured to receive a corresponding protrusion 96 extending from the bottom surface 100 of the support member 60 (FIG. 6). The grooves 104 on the support plate 56 extend in a longitudinal direction, generally perpendicular to the forward cutting edge 76 of the lower blade 48. In other embodiments, the support plate may be integrally formed with the lower blade or the aperture or grooves may be formed in the lower blade.

FIGS. 4-6 illustrate the support member 60, which is configured to rest upon the support plate 56 of the lower blade 48. The support member 60 includes a support bar 61 that extends over the upper blade 52. The support member 60 includes four protrusions 96 (FIG. 6) extending from the bottom surface 100 of the support member 60. Each of the protrusions 96 is configured to be slidingly received in the corresponding groove 104 (FIG. 4) of the support plate 56. Although FIG. 6 shows four protrusions 96 extending from the support member 60 and FIG. 4 shows four grooves 104 formed in the support plate 56, in other embodiments, fewer or more protrusions may extend from the support member and fewer or more grooves may be formed in the support plate.

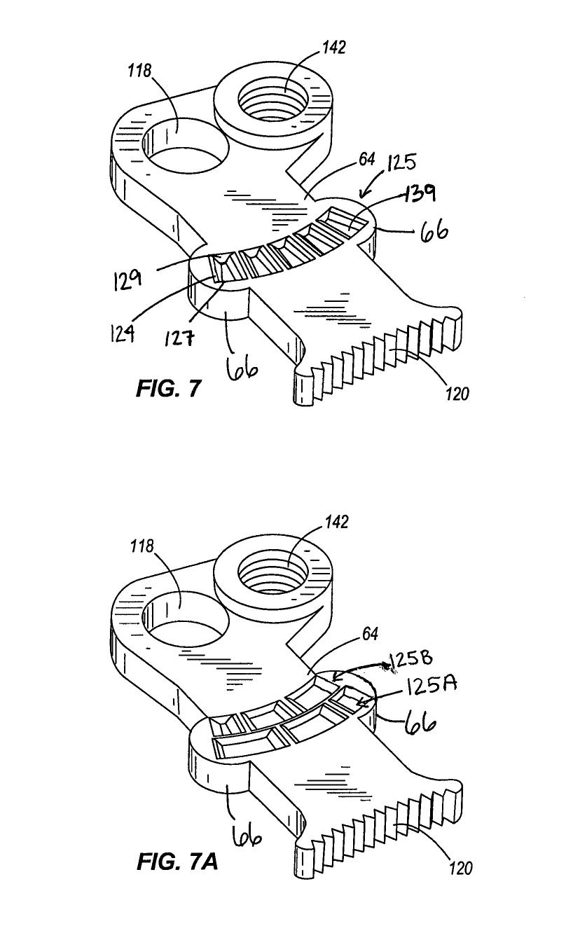

The support member 60 also includes a boss 116 that extends from the bottom surface 100 of the support member 60 (FIG. 6). The boss 116 is configured to couple to an attachment area 118 of the actuation member 64. The actuation member 64 (FIG. 7) is pivotally coupled to the support member 60 at the boss 116 and extends outwardly from the lower blade 48 through an opening 65 defined by the support member 60 and the lower blade 48. The opening 65 further includes a semicircular rib or bump 69 formed on each side of the opening 65 (FIGS. 6 and 6A). The bumps 69 define the outer limits of movement of the actuation member 64 within the opening 65. The actuation member 64 includes an actuation end 120, which is configured to allow a user to pivot and manipulate the actuation member 64 about the boss 116. The actuation member 64 is configured to provide an operator adjustable cut length by changing the longitudinal position of the lower blade 48 upon pivoting or other manipulation of the actuation member 64. The actuation member 64 includes an extension 66 on each side of the actuation member 64 configured to be received within a recess 67 formed in the support member 60. The extension 66 and recess 67 provide additional clearance to pivot or otherwise manipulate the actuation member 64 within the opening 65 to adjust to various cut lengths.

As shown in FIGS. 4, 7, and 7A, the actuation member 64 includes a pin receptacle 142 configured to retain an actuation member pin 140. The actuation member 64 also includes a plurality of wedge-shaped notches 124 configured to slidingly receive a wedge-shaped projection 128 (FIG. 6) or projections 128A, 128B (FIG. 6A) extending from the support member 60. The notches 124 correspond to various intermediate positions of the lower blade 48 between the first position 84 and a second or extended position 152 (FIG. 9). The notches 124 are positioned in an arcuate row 125 such that each notch 124 is angled at approximately ten-degrees from an adjacent notch with respect to the attachment area 118. Each notch 124 is approximately 0.046 inches wide at a first notch part 127 and tapers to approximately 0.039 inches at a second notch part 129. Each notch 124 is approximately 0.025 inches deep. Each notch 124 is also configured to have an approximately thirty-degree incline on each side of the notch to form the wedge shape. Each notch 124 is configured such that the length of the notch is greater than the width of the notch. The notches 124 are the same size; however, in other embodiments, the notches may be of varying size which are still operable to slidingly receive the projection 128.

The projection 128 is positioned on beam 131 which has a free end 133 that allows the beam 131 to flex as the projection 128 is moved along the row of notches 125. The projection 128 is approximately 0.042 inches wide at a first projection part 135 and tapers to approximately 0.035 inches at a second projection part 137. The projection 128 extends from the support member 60 approximately 0.020 inches. The projection 128 is configured to be slidingly received within a corresponding notch 124 without touching a bottom 139 of the notch 124. Upon movement of the actuation member 64, the projection 128 rides within the row of notches 125 to provide an auditory and tactile indication to the user indicating movement of the actuation member 64 and corresponding movement of the lower blade 48, such that the user can feel the movement and hear the interaction of the projection 128 with each of the plurality of notches 124 as the projection 128 is moved throughout the row of notches 125. Although the projection and notches are shown as wedge-shaped, the projection and notches may be other shapes, including, but not limited to spherical, square, and pyramidal.

Referring to FIGS. 6A and 7A, the actuation member 64 may include a first row of notches 125A and a second row of notches 125B (FIG. 7A), and the support member 60 may include a first wedge-shaped projection 128A and a second wedge-shaped projection 128B (FIG. 6A) on beam 131. The notches in the first row of notches 125A are of varying width, and the notches in the second row of notches 125B are of varying width. The various widths accommodate the interaction of the two projections 128A, 128B within the two rows of notches 125A, 125B and provide additional auditory and tactile feedback to the user as compared to a single projection and a single row of notches. The first and second rows of notches 125A, 125B also permit auditory and tactile feedback to the user if either of the rows of notches becomes obstructed with hair or an accumulation of oil. In the illustrated embodiment, the second projection 128B is smaller than the first projection 128A because the second projection 128B is closer to the attachment area 118. The first projection 128A is sized to ride within the first row of notches 125A, and the second projection 128B is sized to ride within the second row of notches 125B. In other embodiments, the first projection and the second projection may be the same size. In still other embodiments, the two rows of notches may have equal size notches.

The notch 124 and the projection 128 configuration also provides a locking function to prevent movement of the lower blade 48 without user movement of the actuation member 64. In the illustrated embodiment, the actuation member is a lever; however, in other embodiments, the actuation device may be a dial adjustment wheel or other actuation member capable of providing a pivoting force or other force to adjust the longitudinal position of the lower blade 48.

The support member 60 further includes a slot 132 extending between a top surface 99 and the bottom surface 100 of the support member and defining an arcuate path 136. The slot 132 is configured to receive the actuation member pin 140 coupled to the actuation member 64 and further defines the movement distance of the lower blade 48. Pin 140 is coupled to the support plate 56 at the aperture 58, thereby upon pivoting of the actuation member 64 by the user and movement of the pin 140 in the arcuate path 136, the necessary force is provided to move the lower blade 48 in a corresponding longitudinal direction. In the illustrated embodiments, the actuation member pin 140 is a screw; however, in other embodiments, the actuation member fastener may be a peg, a nail, rivet, or other suitable pin to move and ride within the slot. The support member 60 also includes a tab 144 on a rear portion 148 of the support member 60. The tab 144 is configured to releasably couple the blade assembly 14 to the housing 18 of the hair trimmer 10.

The yoke 68 is coupled to an upper surface 92 of the upper blade 52, and is configured to provide a connection for a drive pin of the trimmer motor (not shown). During operation, the drive pin oscillates the upper blade 52 back and forth in a direction indicated by arrow 53 (FIGS. 8 and 9), via the yoke 68, such that the upper blade 52 is driven in a transverse direction relative to the forward cutting edge 76 of the lower blade 48 to cut hair. The biasing member 72 is retained by the support member 60 and configured to bias the yoke 68 and the upper blade 52 against the lower blade 48. In the illustrated embodiment, the biasing member is a spring. However, in other embodiments, the biasing member is any element configured to provide a force to bias the yoke and the upper blade against the lower blade.

To adjust cut length, the lower blade 48 is configured to move relative to the hair trimmer 10 in a longitudinal direction perpendicular to the forward cutting edge 80 of the upper blade 52. More specifically, the lower blade 48 is movable between the first position 84 (FIG. 8) and the second position 152 (FIG. 9) to adjust a cut length of hair by pivoting the actuation member 64. As shown in FIG. 8, the first position 84 defines a lower blade position wherein the forward cutting edge 76 of the lower blade 48 is substantially adjacent the forward cutting edge 80 of the upper blade 52. FIG. 9 illustrates the second position 152 wherein the forward cutting edge 76 of the lower blade 48 is longitudinally extended from the forward cutting edge 80 of the upper blade 52. The upper blade 52 is stationary relative to the housing 18 of the hair trimmer 10 during movement of the lower blade 48, and the lower blade 48 moves independently of the upper blade 52.

More specifically, to adjust the cut length of hair, the user pivots or otherwise manipulates the actuation member 64 to move the lower blade 48 from the first position 84 to the second position 152. Pivoting the actuation member 64 causes movement of the lower blade 48 in a corresponding longitudinal direction as the actuation member 64 pivots about the boss 116 of the support member 60. The pin 140 rides within the slot 132 formed in the support member 60, and the protrusions 96 also slide within grooves 104 of the support plate 56 to further direct the longitudinal movement of the lower blade 48. As the actuation member 64 is pivoted, pin 140 moves from a rear portion 160 of the slot 132 to a forward portion 156 of the slot 132, thereby moving the lower blade 48 in a corresponding longitudinal direction. More specifically, as shown in FIG. 8, when the lower blade 48 is in the first position 84, the actuation member pin 140 is positioned in the rear portion 160 of the slot 132. As the actuation member 64 is pivoted, the actuation member pin 140 rides in the slot 132 to the forward portion 156 of the slot 132 and the lower blade 48 moves to the second position 152. When the actuation member pin 140 has reached the forward portion 156 of the slot 132, the lower blade 48 cannot be longitudinally extended any further. To return the lower blade 48 to the first position 84, the actuation member 64 is pivoted in the opposite direction, which moves the pin 140 to the rear portion 160 of the slot 132.

Pivoting the actuation member 64 provides the corresponding force necessary to move the lower blade 48 in the longitudinal direction since the actuation member 64 is coupled to the lower blade 48 (via the support plate 56). As the lower blade 48 is moved from the first position 84 to the second position 152, the lower blade 48 is also moved into a plurality of predetermined intermediate positions corresponding to the notches 124 formed in the actuation member 64. Movement of the projection 128 between the notches 124 in the actuation member 64 provides the auditory and tactile indication to the operator to indicate the amount of movement of the lower blade 48. Furthermore, the length of the slot 132 formed in the support member 60 defines the movement distance of the lower blade 48 with respect to the upper blade 52.

Various features and advantages of the invention are set forth in the following claims.

What is claimed is:

1. A blade assembly for a hair trimmer having a trimmer body and a motor, the blade assembly comprising:
an upper blade having a forward cutting edge;
a lower blade having a forward cutting edge and defining a groove;
a support member configured for coupling to the trimmer body and having a protrusion, wherein the protrusion is configured to be slidingly received in the groove of the lower blade;
an actuation member coupled to the lower blade and extending outwardly from the lower blade; and
a biasing member retained by the support member and configured to bias the upper blade against the lower blade;
wherein the upper blade is configured to oscillate in a transverse direction relative to the forward edge of the lower blade during operation of the motor; and
further wherein the lower blade is configured to move relative to the hair trimmer in a longitudinal direction perpendicular to the forward edge of the upper blade upon movement of the actuation member.

2. The blade assembly of claim 1 wherein the blade assembly is releasably coupled to the trimmer body.

3. The blade assembly of claim 1, and further comprising a support plate coupled to the lower blade, wherein the support plate defines the groove.

4. The blade assembly of claim 1 wherein the actuation member is positioned between the lower blade and the support member.

5. The blade assembly of claim 1 wherein the actuation member is configured to move the lower blade between a first position and a second position to adjust a cut length of the blade assembly.

6. The blade assembly of claim 5 wherein the actuation member is further configured to move the lower blade to a plurality of predetermined intermediate positions between the first position and the second position.

7. The blade assembly of claim 6, and further comprising a projection extending from the support member and a plurality of notches formed in the actuation member, wherein the intermediate positions are defined by movement of the projection along the notches.

8. The blade assembly of claim 6, and further comprising first and second projections extending from the support member and first and second rows of notches formed in the actuation member, wherein the intermediate positions are defined by movement of the first projection along the first row of notches and movement of the second projection along the second row of notches.

9. The blade assembly of claim 1, and further comprising a pin for coupling the actuation member to the lower blade and a slot formed in the support member, wherein the pin is configured for moving along a path defined by the slot when the actuation member is actuated by a user and the slot defines movement distance of the lower blade.

10. The blade assembly of claim 1 wherein the actuation member comprises a lever pivotally coupled to the support member.

11. The blade assembly of claim 1 wherein upon actuation of the actuation member the groove slides along the protrusion to allow movement of the lower blade relative to the support member.

12. The blade assembly of claim 1 wherein the upper blade is stationary with respect to movement of the lower blade.

13. A hair trimmer comprising:
a housing;
a motor at least partially disposed in the housing; and
a blade assembly coupled to the housing and drivingly connected to the motor to effect a cutting action, the blade assembly comprising,
an upper blade having a forward cutting edge,
a lower blade having a forward cutting edge and defining a groove,
a support member configured for coupling the blade assembly to the housing and having a protrusion, wherein the protrusion is configured to be slidingly received in the groove of the lower blade,
an actuation member coupled to the lower blade and extending outwardly from the lower blade, and
a biasing member retained by the support member and configured to bias the upper blade against the lower blade,
wherein the upper blade is configured to oscillate in a transverse direction relative to the forward edge of the lower blade during operation of the motor, and
further wherein the lower blade is configured to move relative to the hair trimmer in a longitudinal direction perpendicular to the forward edge of the upper blade upon movement of the actuation member.

14. The hair trimmer of claim 13 wherein the blade assembly is releasably coupled to the housing.

15. The hair trimmer of claim 13, and further comprising a support plate coupled to the lower blade, wherein the support plate defines the groove.

16. The hair trimmer of claim 13 wherein the actuation member is positioned between the lower blade and the support member.

17. The hair trimmer of claim 13 wherein the actuation member is configured to move the lower blade between a first position and a second position to adjust a cut length of the blade assembly.

18. The hair trimmer of claim 17 wherein the actuation member is further configured to move the lower blade to a plurality of predetermined intermediate positions between the first position and the second position.

19. The hair trimmer of claim 18, and further comprising a projection extending from the support member and a plurality of notches formed in the actuation member, wherein the intermediate positions are defined by movement of the projection along the notches.

20. The hair trimmer of claim 13, and further comprising a pin for coupling the actuation member to the lower blade and a slot formed in the support member, wherein the pin is configured for moving along a path defined by the slot when the actuation member is actuated by a user and the slot defines movement distance of the lower blade.

21. The hair trimmer of claim 13 wherein the upper blade is stationary with respect to movement of the lower blade.

22. The hair trimmer of claim 13, and further comprising a yoke coupled to an upper surface of the upper blade and retained in the support member by the biasing element.

23. A blade assembly for a hair trimmer having a trimmer body and a motor, the blade assembly comprising:
an upper blade having a forward cutting edge;
a lower blade having a forward cutting edge;
a support plate coupled to the lower blade and defining a groove;
a support member configured for attachment to the trimmer body and having a protrusion, wherein the protrusion is configured to be slidingly received in the groove of the support plate;
an actuation member coupled to the support plate and pivotally coupled to the support member, the actuation member having an actuation end extending outwardly from the lower blade, wherein the actuation member is configured to adjust a cut length of the blade assembly by moving the lower blade in a longitudinal direction between a first position and a second position;
a biasing member retained by the support member and configured to bias the upper blade against the lower blade; and
a yoke member supported by the upper blade and drivingly coupled to the motor, wherein the upper blade oscillates in a transverse direction relative to the forward edge of the lower blade during operation of the motor.

24. The blade assembly of claim 23 wherein the blade assembly is releasably coupled to the trimmer body.

25. The blade assembly of claim 23 wherein the actuation member is positioned between the support plate and the support member.

26. The blade assembly of claim 23 wherein the actuation member is further configured to move the lower blade to a plurality of predetermined intermediate positions between the first position and the second position.

27. The blade assembly of claim 26, and further comprising a projection extending from the support member and a plurality of notches formed in the actuation member, wherein the intermediate positions are defined by movement of the projection along the notches.

28. The blade assembly of claim 23, and further comprising a pin for coupling the actuation member to the support plate and a slot formed in the support member, wherein the pin is configured for moving along a path defined by the slot when the actuation member is actuated by a user and the slot defines movement distance of the lower blade.

29. A blade assembly for a hair trimmer having a trimmer body and a motor, the blade assembly comprising:
an upper blade having a forward cutting edge;
a lower blade having a forward cutting edge and defining a groove;
an actuation member coupled to the lower blade and extending outwardly from the lower blade, wherein the actuation member includes a plurality of rows of notches;
a support member configured for coupling to the trimmer body and having a protrusion and a plurality of projections corresponding to the plurality of rows of notches, wherein the protrusion is configured to be slidingly received in the groove of the lower blade and the plurality of projections is configured to be slidingly received in the plurality of rows of notches; and
a biasing member retained by the support member and configured to bias the upper blade against the lower blade.

30. The blade assembly of claim 29 wherein the actuation member is configured to move the lower blade in a longitudinal direction perpendicular to the forward edge of the upper blade between a first position and a second position to adjust a cut length of the blade assembly.

31. The blade assembly of claim 30 wherein the actuation member is further configured to move the lower blade to a plurality of predetermined intermediate positions between the first position and the second position.

32. The blade assembly of claim 31 wherein the intermediate positions are defined by movement of a first projection along a first row of notches and movement of a second projection along a second row of notches.
